(19) United States
(12) Patent Application Publication
(10) Pub. No.: US 2025/0063413 A1
(43) Pub. Date: Feb. 20, 2025

(54) INTERWORKING OF MULTIPLE UNIVERSAL SUBSCRIBER IDENTITY MODULE GAPS AND MEASUREMENT GAPS

(71) Applicant: Nokia Technologies Oy, Espoo (FI)

(72) Inventors: Srinivasan SELVAGANAPATHY, Bangalore (IN); Faranaz SABOURI-SICHANI, Aalborg (DK); Tero HENTTONEN, Espoo (FI); Lars DALSGAARD, Oulu (FI)

(21) Appl. No.: 18/721,971

(22) PCT Filed: Jan. 12, 2023
(86) PCT No.: PCT/IB2023/050293

§ 371 Date: Jun. 20, 2024

(30) Foreign Application Priority Data
Jan. 17, 2022 (IN) 202241002592

(51) Int. Cl. H04W 24/10

(52) U.S. Cl. CPC H04W 24/10

(57) ABSTRACT

Systems, methods, apparatuses, and computer program products for interworking of measurements gaps and measurement gaps for multiple universal subscriber identity module user equipment are provided. For example, a method can include preparing a gap request to request a gap from a first network for performing an operation with respect to a second network. The gap request can include an indication of criticality of the gap. The method can also include transmitting the gap request from a user equipment to the first network.

### CROSS-REFERENCE TO RELATED APPLICATION

This application is related to and claims the priority of Indian Provisional Patent Application No. 20/224,1002592, filed Jan. 17, 2022, the entirety of which is hereby incorporated herein by reference.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for interworking of measurements gaps and measurement gaps for multiple universal subscriber identity module user equipment.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus that may include at least one processor and at least one memory comprising computer program code. The at least one memory and computer program code can be configured, with the at least one processor, to cause the apparatus at least to perform preparing a gap request to request a gap from a first network for performing an operation with respect to a second network. The gap request can include an indication of criticality of the gap. The at least one memory and computer program code can also be configured, with the at least one processor, to cause the apparatus at least to perform transmitting the gap request from a user equipment to the first network.

An embodiment may be directed to an apparatus that may include at least one processor and at least one memory comprising computer program code. The at least one memory and computer program code can be configured, with the at least one processor, to cause the apparatus at least to perform receiving a gap request, from a user equipment, to request a gap from a first network for performing an operation with respect to a second network. The gap request can include an indication of criticality of the gap. The at least one memory and computer program code can be configured, with the at least one processor, to cause the apparatus at least to perform reconfiguring measurement gaps to avoid overlap with the gap or indicating to the user equipment that the user equipment can use the gap for operation with respect to the second network.

An embodiment may be directed to a method that can include preparing a gap request to request a gap from a first network for performing an operation with respect to a second network. The gap request can include an indication of criticality of the gap. The method can also include transmitting the gap request from a user equipment to the first network.

An embodiment may be directed to a method that can include receiving a gap request, from a user equipment, to request a gap from a first network for performing an operation with respect to a second network. The gap request can include an indication of criticality of the gap. The method can also include reconfiguring measurement gaps to avoid overlap with the gap or indicating to the user equipment that the user equipment can use the gap for operation with respect to the second network.

An embodiment may be directed to an apparatus that can include means for preparing a gap request to request a gap from a first network for performing an operation with respect to a second network. The gap request can include an indication of criticality of the gap. The apparatus can also include means for transmitting the gap request from a user equipment to the first network.

An embodiment may be directed to an apparatus that can include means for receiving a gap request, from a user equipment, to request a gap from a first network for performing an operation with respect to a second network. The gap request can include an indication of criticality of the gap. The apparatus can also include means for reconfiguring measurement gaps to avoid overlap with the gap or indicating to the user equipment that the user equipment can use the gap for operation with respect to the second network.

### BRIEF DESCRIPTION OF THE DRAWINGS

For proper understanding of example embodiments, reference should be made to the accompanying drawings, wherein:

FIG. 1 illustrates gap configurations and their associated signaling procedures;

FIG. 2 illustrates user equipment assistance information, according to certain embodiments;

FIG. 3 illustrates a multiple universal subscriber identity module gap configuration, according to certain embodiments;

FIG. 4 illustrates an example flow diagram of a method, according to an embodiment;

FIG. 5 illustrates another example flow diagram of a method, according to an embodiment;

FIG. 6 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing interworking of measurements gaps and measurement gaps for multiple universal subscriber identity module user equipment, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Multiple universal subscriber identity module (SIM) (MUSIM) user equipment may benefit from enabling user equipment (UE) switching between network A (NTWK-A), where the UE is in radio resource control (RRC) connected mode and network B (NTWK-B) where other USIM is in RRC-IDLE for enabling Idle mode operations with minimum impact to connected mode operation in NTWK-A. For the purpose of such switching, certain embodiments relate to a signaling procedure for UE providing assistance information indicating need for MUSIM gaps followed by NW configuration of MUSIM gap. Two types of gap configurations can be supported: periodic gaps for radio resource management (RRM) measurements and paging monitoring at NTWK-B and aperiodic gaps for short signaling procedure or for system information acquisition at NTWK-B.

Throughout the following discussion, NTWK-A can be used to refer to the network corresponding to the UE's USIM in RRC_CONNECTED and NTWK-B can be used to refer to the network corresponding to the UE's USIM that is in RRC_IDLE or RRC_INACTIVE. The labels A and B are, therefore, only for convenience and ease of reference, and not by way of preference or priority. There can be multiple NTWK-Bs even though one is shown. The UE operating with respect to NTWK-B can be referred to as UE-B.

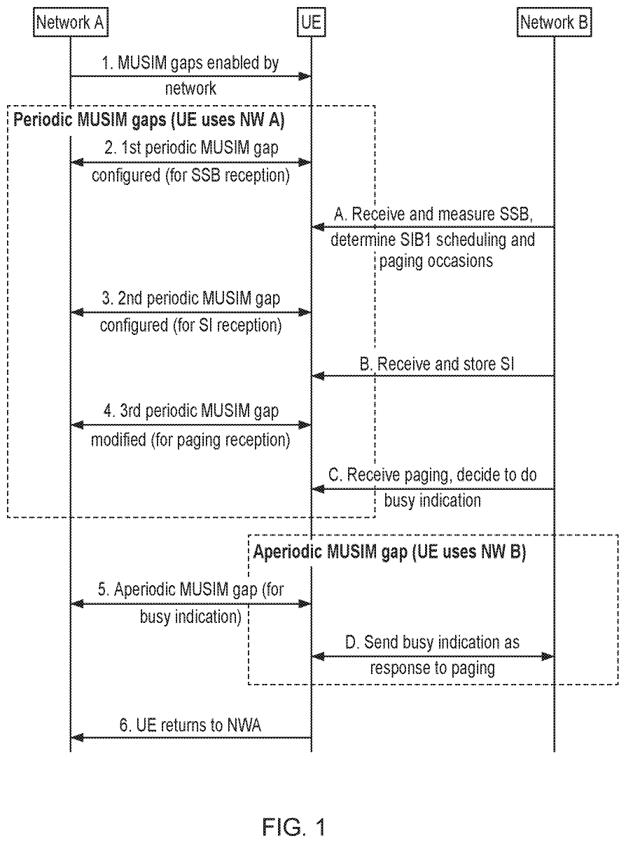

FIG. 1 illustrates gap configurations and their associated signaling procedures. As shown in FIG. 1, network A can indicate, at 1, to the UE that MUSIM gaps are enabled by the network. With periodic MUSIM gaps and UE using network (NW) A, at 2, there can be first periodic MUSIM gap, which can be configured for synchronization signal block (SSB) reception. Meanwhile, at A, the UE may receive and measure SSB from network B, and determine system information block (SIB) 1 scheduling and paging occasions.

At 3, there may be a second periodic MUSIM gap, which may be configured for system information (SI) reception. At B, the UE may receive and store SI from network B.

At 4, there may be a third periodic MUSIM gap, which may be a modified version of the second perioidic MUSIM gap, and which may be for paging reception. At C, the UE may receive paging from network B and may decide to provide a busy indication.

Aperiodic MUSIM gap may allow the UE to use network B. For example, network A may provide an aperiodic MUSIM gap for a busy indication. Accordingly, at D, the UE may send a busy indication as response to a paging. Then, at 6, the UE may return to network A.

Certain embodiments may be applicable to cases where a particular UE has two or more USIMs with limited hardware. Thus, such UEs may benefit from a gap in RRC connection on one USIM while the UE can perform idle/inactive procedures on one or more other USIM.

Interworking of measurement gaps for connected mode operation and MUSIM gaps, also referred as network switching gaps (NSG), there may be an absence of additional RRM requirements. In other words, if the gap configurations of MUSIM and measurement gaps are overlapping, the connected mode operations may remain unaffected.

Such a restriction, to ensure that the connected mode operations are unaffected, may impact the idle mode operations at a UE-B that is in RRC-IDLE/RRC_INACTIVE mode at NTWK-B for paging reception and may also impact cell reselection related measurements that may be needed for idle mode mobility. Certain embodiments provide signaling procedures that may minimize the impacts. More specifically, certain embodiments may provide changes to the MUSIM gap configuration related procedure.

For example, certain embodiments may provide a technical way to address MUSIM gap for paging reception overlapping with measurement gap (MG).

A new parameter, Gap-Non-Preemptable, may be added to the UE's gap request in UEAssistanceInformation message indicating whether the gap is critical for idle mode operation. The UE can set this parameter for the MUSIM gap patterns with high priority and less flexibility, such as gap patterns associated with paging reception. Alternatively, the indication can be sent as a parameter, Gap-Priority, in MUSIM assistance information. Thus, this indication of criticality can also be referred to as an indication of priority.

On reception of MUSIM gap assistance information that cannot be pre-empted for measurement gaps, the network may either reconfigure the measurement gaps to avoid the overlap. Alternatively, the network may indicate to the UE in a radio resource control (RRC) reconfiguration (RRCReconfiguration) message that the UE can make use of the gap for NTWK-B operation for specific gap pattern if the gap overlaps with NTWK-A measurement gaps. A new parameter, skip-MG-for-NSG' is included in the Gap-configuration for specific gap pattern.

The reconfiguration can be provided by NTWK-A if NTWK-A deduces that giving away one measurement gap out of N measurement gaps, as per the current periodicity, does not have a major impact on connected mode measurements. In certain embodiments, the NW may consider performing measurements gaps to be less critical when the user equipment is not at cell edge and/or the user equipment is in low mobility. Low mobility and/or position may be determined based on received measurement reports from the UE.

If the MUSIM Gap for paging reception overlaps with MG and if NTWK-A did not include skip-MG parameter, the UE may trigger a paging collision avoidance procedure with NTWK-B to change the paging occasion (PO) location.

Certain embodiments may provide a technical approach to overriding for cell reselection measurements. If MUSIM gap for idle mode RRM measurements overlap with MG, the UE can continue to do the measurements with limited gap configuration for serving cell measurements. On the other hand, if there is a need to trigger neighboring cell measurements on other frequencies using this gap for cell-reselection, the UE may need to make use of the gaps that were shared with MG. The UE may indicate MUSIM assistance information with a timer value for the parameter, gap-override for NTWK-B, in this case.

If skipping connected mode measurements for the short duration given in the UE assistance information is acceptable, the NW may include a parameter, Temp-MG-skip-enabled, with a timer value that is acceptable by the NW in an RRC Reconfiguration message. The parameter is included without an explicit timer value, the UE may assume that the timer value the UE provided is acceptable.

If there is no response for to the Gap-override information, the UE may continue with current restricted measurement gaps for cell-reselection measurements also.

Certain embodiments may address radio access network (RAN) sharing deployment. If a serving cell supports RAN sharing and both public land mobile networks (PLMNs) of MUSIM operation are supported in the same cell, the UE may indicate that the MG can be reused for a given MUSIM gap. The indication from the UE may include a parameter, MG-reuse. On receiving the parameter, MG-reuse, the

NW may ensure that either MG or MUSIM-Gap that indicates this parameter is configured to the UE. Such a configuration or reconfiguration may avoid redundant gap configuration for MUSIM operation.

Thus, certain embodiments may rely on various parameters. For example, a parameter, Gap-Non-preemptable, can be include in UE assistance information for MUSIM gap request for paging monitoring. As another example, a parameter, Gap-override-timer, can be included for MUSIM gap pattern for temporary overriding of MG gap for MUSIM gap for cell reselection measurements. As a further example, parameters, skip-MG, for gap configuration and Temp-MG-Skip-Enabled and Timer-for-temp-MG-Skip can be included in the MUSIM Gap configuration field within other-config. A parameter, MG reuse, can be used to inform the network MG measurements can be reused for MUSIM purpose in case of RAN-sharing.

The RRC message parameter changes for the primary methods are provided in this section.

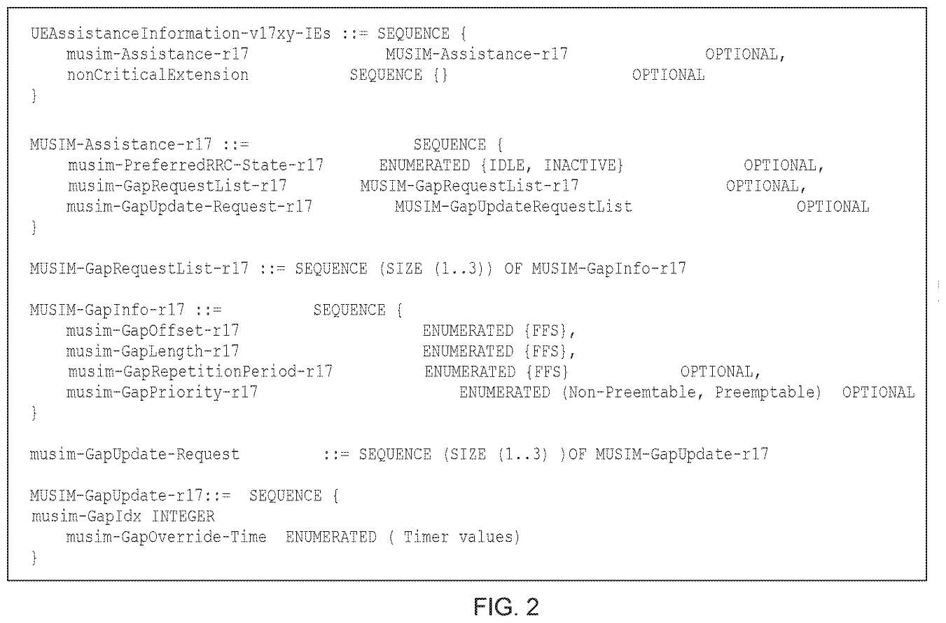

FIG. 2 illustrates user equipment assistance information, according to certain embodiments. There can be various modifications to UE assistance information for MUSIM gaps. The parameters and other information elements in FIG. 2 are provided by way of example.

In FIG. 2, the Musim-GapPriority field can indicate that the MUSIM gap requested location cannot be changed or shared. If a shared UE prefers to use the gap for MUSIM operation, the UE may so indicate with this field. The MUSIM-GapUpdate filed can be used to modify the current gap configuration from the UE. The Musim-GapOverride-Time field can indicate that the MUSIM operation is needed on this gap, overriding the MG operation for a short time, the length of which can be indicated in the musim-GapOverride-Time field.

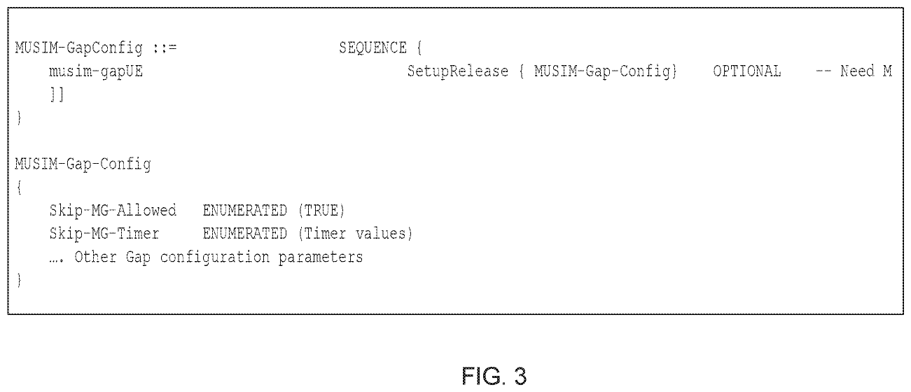

FIG. 3 illustrates a multiple universal subscriber identity module gap configuration, according to certain embodiments. In FIG. 3, if MG and MUSIM gap are overlapping, the Skip-MG-Allowed field can indicate that the UE can skip MG for MUSIM operation. This field can be set based on a UE request in MUSIM assistance information. If this field is not present, the UE may not skip MG. In this case, if the MUSIM operation on this gap will not be possible, the UE may trigger paging collision avoidance to change the gap location/configuration. The Skip=-MG-Timer field can indicate that a temporary skipping of MG for MUSIM is allowed for a given duration. If this field is not present, skipping may be forbidden, and the UE may continue to use a restricted gap for MUSIM operation.

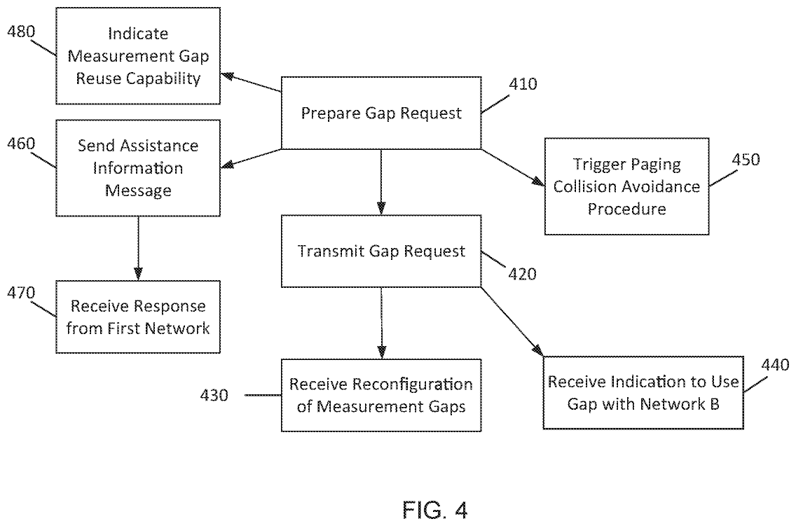

FIG. 4 illustrates an example flow diagram of a method for interworking of measurements gaps and measurement gaps for multiple universal subscriber identity module user equipment, according to certain embodiments.

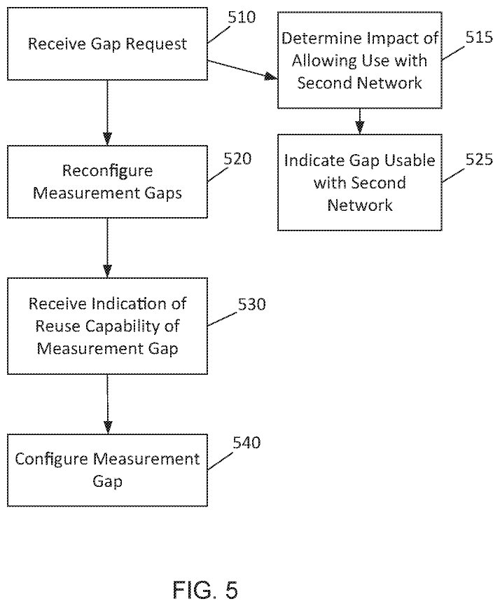

As shown in FIG. 4, a method can include procedures performed by a user equipment. The procedures performed by the user equipment in FIG. 4 can be performed in combination with the procedures performed by the base station or other network element in FIG. 5, or separately from one another.

As shown in FIG. 4, a method can include, at 410, preparing a gap request to request a gap from a first network for performing an operation with respect to a second network. The gap request can include an indication of criticality of the gap. The criticality of the gap can include criticality of the gap for idle mode operation. The method can also include, at 420, transmitting the gap request from a user equipment to the first network.

The method can further include, at 430, receiving a reconfiguration of measurement gaps to avoid overlap with the gap. As another option or alternative, or on another occasion, the method can also include, at 440, receiving an indication that the user equipment can use the gap for operation with respect to the second network.

When the gap overlaps with another measurement gap and no indication that the user equipment can use the gap for operation with respect to the second network has been received (for example, the indication at 440 has not been received), the method can include, at 450, triggering a paging collision avoidance procedure with the second network to change a paging occasion location

The method can further include, at 460, sending an assistance information message to the first network requesting to skip connected mode measurements for a first period of time. Moreover, the method can include, at 470, receiving a response from the first network permitting skipping connected mode measurements. The response can indicate a second period of time for the skipping connected mode measurements. The second period can be the same as the first period, or the second period may differ from the first period.

The method can further include, at 480, indicating to the first network that the measurement gap can be reused.

In the method of FIG. 4, the various procedures can be performed in a different order than shown, and certain embodiments may include only some of the procedures. To implement the various procedures, the information elements and fields discussed above and illustrated in FIGS. 2 and 3 may be used.

It is noted that FIG. 4 is provided as one example embodiment of a method or process. However, certain embodiments are not limited to this example, and further examples are possible as discussed elsewhere herein.

FIG. 5 illustrates an example flow diagram of a method for interworking of measurements gaps and measurement gaps for multiple universal subscriber identity module user equipment, according to certain embodiments. The procedures performed by the network element in FIG. 5 can be performed in combination with the procedures performed by the user equipment in FIG. 4, or separately from one another. The information elements and other fields of FIGS. 2 and 3 may be used in the implementation of the method of FIG. 5.

As shown in FIG. 5, a method can include, at 510, receiving a gap request, from a user equipment, to request a gap from a first network for performing an operation with respect to a second network. The gap request can include an indication of criticality of the gap. This may be the same gap request transmitted at 420. The method of FIG. 5 can also include, at 520, reconfiguring measurement gaps to avoid overlap with the gap, which can be the same reconfiguration received at 430 in FIG. 4. As another option, the method of FIG. 5 can include, at 525, indicating to the user equipment that the user equipment can use the gap for operation with respect to the second network. This can be the same indication received at 440 in FIG. 4.

The method of FIG. 5 can further include, at 515, determining an impact of allowing the user equipment to use the gap for operation with respect to the second network. The indicating to the user equipment at 525 can be in accordance with the determination. The determining can take into account a position or mobility level of the user equipment. For example, allowing the user equipment to use the gap for operation with the second network may be more readily permitted if the user equipment is near the center of the cell or stationary.

The method of FIG. 5 can also include, at 530, receiving an indication from the user equipment that the measurement gap can be reused. This may be the same indication sent at 480 in FIG. 4. The method of FIG. 5 can also include, at 540, configuring the measurement gap in accordance with the indication.

It is noted that FIG. 5 is provided as one example embodiment of a method or process. However, certain embodiments are not limited to this example, and further examples are possible as discussed elsewhere herein.

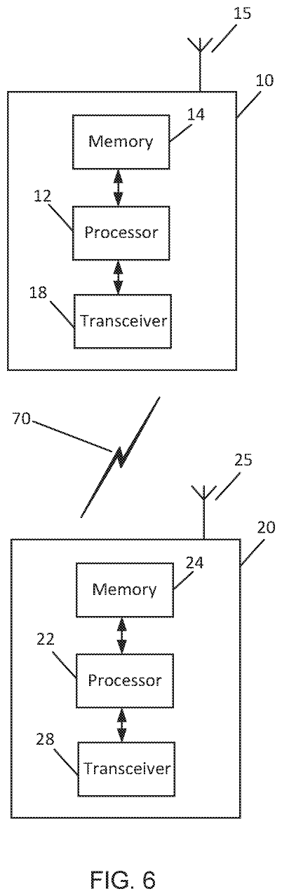

FIG. 6 illustrates an example of a system that includes an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be co-located in an entity communicating within the entity via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. Additionally, the DU may be provided with one or more RU, as described above. It should be noted that one of ordinary skill in the art would understand that apparatus 10 may include components or features not shown in FIG. 6.

As illustrated in the example of FIG. 6, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 6, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-5, or any other method described herein. In some embodiments, as discussed herein, apparatus 10 may be configured to perform a procedure relating to interworking of measurements gaps and measurement gaps for multiple universal subscriber identity module user equipment, for example.

FIG. 6 further illustrates that the example system can include an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 6.

As illustrated in the example of FIG. 6, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-5, or any other method described herein. For example, in an embodiment, apparatus 20 may be controlled to perform a process relating to providing support for interworking of measurements gaps and measurement gaps for multiple universal subscriber identity module user equipment, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may provide interworking of measurements gaps and measurement gaps for multiple universal subscriber identity module user equipment. Thus, for example, certain embodiments may provide an efficient use of measurement gaps, avoiding unnecessary or redundant measurement gaps, while ensuring adequate measurement gaps for needed measurements.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### LIST OF ABBREVIATIONS

MG Measurement Gap
MUSIM Multiple Universal Subscriber Identity Module
NSG Network Switching Gaps
RRC Radio Resource Control
RRM Radio Resource Management
UAI UE Assistance Information
UE User Equipment

1-46. (canceled)

47. An apparatus, comprising:
at least one processor; and
at least one memory including computer program code,
wherein the at least one memory and the computer program code are configured to, with the at least one processor, cause the apparatus at least to perform
preparing a gap request to request a gap from a first network for performing an operation with respect to a second network, wherein the gap request comprises an indication of criticality of the gap; and
transmitting the gap request to the first network.

48. The apparatus of claim 47, wherein the criticality of the gap comprises criticality or priority of the gap for operation in the second network.

49. The apparatus of claim 47, wherein the at least one memory and the computer program code are further configured to, with the at least one processor, cause the apparatus at least to perform
receiving a reconfiguration of measurement gaps to avoid overlap with the gap requested.

50. The apparatus of claim 47, wherein the at least one memory and the computer program code are further configured to, with the at least one processor, cause the apparatus at least to perform
receiving an indication that the apparatus can use the requested gap for operation with respect to the second network.

51. The apparatus of claim 47, wherein the at least one memory and the computer program code are further configured to, with the at least one processor, cause the apparatus at least to perform
when the requested gap overlaps with another measurement gap and no indication that the apparatus can use the requested gap for operation with respect to the second network has been received, triggering a paging collision avoidance procedure with the second network to change a paging occasion location

52. The apparatus of claim 47, wherein the at least one memory and the computer program code are further configured to, with the at least one processor, cause the apparatus at least to perform
sending an assistance information message to the first network requesting to skip connected mode measurements for a first period of time.

53. The apparatus of claim 52, wherein the at least one memory and the computer program code are further configured to, with the at least one processor, cause the apparatus at least to perform
receiving a response from the first network permitting skipping connected mode measurements.

54. The apparatus of claim 53, wherein the response indicates a second period of time for the skipping connected mode measurements.

55. The apparatus of claim 47, wherein the at least one memory and the computer program code are further configured to, with the at least one processor, cause the apparatus at least to perform
indicating to the first network that the measurement gap can be reused.

56. An apparatus, comprising:
at least one processor; and
at least one memory including computer program code,
wherein the at least one memory and the computer program code are configured to, with the at least one processor, cause the apparatus at least to perform
receiving a gap request, from a user equipment, to request a gap from a first network for performing an operation with respect to a second network, wherein the gap request comprises an indication of criticality of the gap; and
reconfiguring measurement gaps to avoid overlap with the requested gap or indicating to the user equipment that the user equipment can use the requested gap for operation with respect to the second network.

57. The apparatus of claim 56, wherein the criticality of the gap comprises criticality or priority of the gap for operation in the second network.

58. The apparatus of claim 56, wherein the at least one memory and the computer program code are further configured to, with the at least one processor, cause the apparatus at least to perform
determining an impact of allowing the user equipment to use the requested gap for operation with respect to the second network, wherein the indicating to the user equipment is in accordance with the determination.

59. The apparatus of claim 58, wherein the determining takes into account a position or mobility level of the user equipment.

60. The apparatus of claim 56, wherein the at least one memory and the computer program code are further configured to, with the at least one processor, cause the apparatus at least to perform
receiving an indication from the user equipment that the measurement gap can be reused; and
configuring the measurement gap in accordance with the indication.

61. A method, comprising:
preparing a gap request to request a gap from a first network for performing an operation with respect to a second network, wherein the gap request comprises an indication of criticality of the gap; and
transmitting the gap request from a user equipment to the first network.

62. The method of claim 61, wherein the criticality of the gap comprises criticality or priority of the gap for operation in the second network.

63. The method of claim 61, further comprising:
receiving a reconfiguration of measurement gaps to avoid overlap with the gap requested.

64. The method of claim 61, further comprising:
receiving an indication that the user equipment can use the requested gap for operation with respect to the second network.

65. The method of claim 61, further comprising:
when the requested gap overlaps with another measurement gap and no indication that the user equipment can use the requested gap for operation with respect to the second network has been received, triggering a paging collision avoidance procedure with the second network to change a paging occasion location

66. The method of claim 61, further comprising:
sending an assistance information message to the first network requesting to skip connected mode measurements for a first period of time.
